(19) United States
(12) Patent Application Publication
(10) Pub. No.: US 2013/0097415 A1
(43) Pub. Date: Apr. 18, 2013

(54) Central Processing Unit Monitoring and Management Based On A busy-Idle Histogram

(71) Applicants: Qing Li, Boulder, CO (US); Sumit Sur, Broomfield, CO (US); Jeffrey A. Niemann, Superior, CO (US); Bohuslav Rychlik, San Diego, CA (US)

(72) Inventors: Qing Li, Boulder, CO (US); Sumit Sur, Broomfield, CO (US); Jeffrey A. Niemann, Superior, CO (US); Bohuslav Rychlik, San Diego, CA (US)

(73) Assignee: QUALCOMM INCORPORATED, San Diego, CA (US)

(21) Appl. No.: 13/349,139

(22) Filed: Jan. 12, 2012

Related U.S. Application Data
(60) Provisional application No. 61/546,184, filed on Oct. 12, 2011.
(60) Provisional application No. 61/583,386, filed on Jan. 5, 2012.

(51) Int. Cl. G06F 9/06

(52) U.S. Cl. 713/100

(57) ABSTRACT

The aspects enable a computing device or microprocessor to adjust the operations of a processor in view of a current processor workload based on a histogram-like data structure. A histogram-like data structure characterizing one of processor busy and/or idle durations or busy/idle ratios is generated at runtime and used to model the processor workload. The processor workload is used to predict future processing requirements and to adjust the processor's operations such that they are commensurate with the processing and workload requirements. The histogram-like data structure may alternatively be used to estimate a current quality of service (QoS) of a communication link so that link management actions may be taken.

### RELATED APPLICATIONS

This application claims the benefit of priority to U.S. Provisional Patent Application No. 61/546,184 entitled “Dynamic Voltage And Clock Scaling Control Based On Running Average, Variant And Trend” filed Oct. 12, 2011 and U.S. Provisional Patent Application No. 61/583,386 entitled “Central Processing Monitoring and Management Based on a Busy-Idle Histogram” filed Jan. 5, 2012 the entire contents of both of which are hereby incorporated by reference.

This application is also related to U.S. patent application Ser. No. 13/301,480 entitled “Dynamic Voltage And Clock Scaling Control Based On Running Average, Variant And Trend” filed Nov. 21, 2011, which also claims the benefit of priority to U.S. Provisional Patent Application No. 61/546,184.

### BACKGROUND

With the recent growth in processor capabilities, diversity, and usefulness of applications, and need for constant wireless communication, the demands on modern smart phones and mobile communication devices have increased dramatically. Users now depend on their mobile devices to support many aspects of their daily lives. Consequently, improvements to mobile computing devices' performance, battery life, and power consumption characteristics are becoming ever more important considerations for consumers.

### SUMMARY

The various aspects include methods of dynamically adjusting the operations of a computing device having a processor, including measuring busy or idle durations of the processor, generating a histogram-like data structure characterizing the processor's workload using the measured busy or idle durations, and using the histogram-like data structure to adjust at least one operational parameter of the computing device. In an aspect, generating a histogram-like data structure characterizing the processor's workload using the measured busy or idle durations includes incrementing by a predefined amount a particular value within a multi-value data structure that corresponds to a measured busy or idle duration, and decrementing all values within the multi-value data structure by a decay factor. In a further aspect, generating a histogram-like data structure characterizing the processor's workload includes generating the histogram-like data structure in two central processing unit (CPU) cycles or less. In a further aspect, using the histogram-like data structure includes adjusting a frequency of voltage of the processor based on the histogram-like data structure. In a further aspect, using the histogram-like data structure includes determining a longest workload quantum based on the histogram-like data structure, generating a model of a predicted future workload based on the histogram-like data structure, and adjusting operational parameters of the processor to be commensurate with the predicted future workloads. In a further aspect, adjusting the operational parameters of the processor to be commensurate with the predicted future workloads includes adjusting an operating frequency of the processor based on the longest workload quantum. In a further aspect, adjusting an operating frequency of the processor includes scaling the voltage or frequency of the processor. In a further aspect, adjusting the operational parameters of the processor to be commensurate with the predicted future workloads includes changing at least one quality of service value. In a further aspect, using the histogram-like data structure includes determining a longest workload quantum within the histogram-like data structure, and determining a quality of service value based on the determined longest workload quantum. In a further aspect, the method further includes controlling a component of the computing device based on the determined quality of service value. In a further aspect, using the histogram-like data structure includes determining a longest workload quanta, comparing the longest workload quantum with a workload natural period, and determining a quality of service value based on this comparison.

Further aspects include computing device having a means for measuring busy or idle durations of a processor, means for generating a histogram-like data structure characterizing the processor's workload using the measured busy or idle durations, and means for using the histogram-like data structure to adjust at least one operational parameter of the computing device. In an aspect, the means for generating a histogram-like data structure characterizing the processor's workload using the measured busy or idle durations includes means for incrementing by a predefined amount a particular value within a multi-value data structure that corresponds to a measured busy or idle duration, and means for decrementing all values within the multi-value data structure by a decay factor. In a further aspect, means for generating a histogram-like data structure characterizing the processor's workload includes means for generating the histogram-like data structure in two central processing unit (CPU) cycles or less. In a further aspect, means for using the histogram-like data structure includes means for adjusting a frequency of voltage of the processor based on the histogram-like data structure. In a further aspect, means for using the histogram-like data structure includes means for determining a longest workload quantum based on the histogram-like data structure, means for generating a model of a predicted future workload based on the histogram-like data structure, and means for adjusting operational parameters of the processor to be commensurate with the predicted future workloads. In a further aspect, means for adjusting the operational parameters of the processor to be commensurate with the predicted future workloads includes means for adjusting an operating frequency of the processor based on the longest workload quantum. In a further aspect, means for adjusting an operating frequency of the processor includes means for scaling the voltage or frequency of the processor. In a further aspect, means for adjusting the operational parameters of the processor to be commensurate with the predicted future workloads includes means for changing at least one quality of service value. In a further aspect, means for using the histogram-like data structure includes means for determining a longest workload quantum within the histogram-like data structure, and means for determining a quality of service value based on the determined longest workload quantum. In a further aspect, the computing device further includes means for controlling a component of the computing device based on the determined quality of service value. In a further aspect, means for using the histogram-like data structure includes means for determining a longest workload quanta, means for comparing the longest workload quantum with a workload natural period, and means for determining a quality of service value based on this comparison.

Further aspects include a computing device having a memory, and a processor coupled to the memory, wherein the processor is configured with processor-executable instructions to perform operations including measuring busy or idle durations of the processor, generating a histogram-like data structure characterizing the processor's workload using the measured busy or idle durations, and using the histogram-like data structure to adjust at least one operational parameter of the computing device. In an aspect, the processor is configured with processor-executable instructions such that generating a histogram-like data structure characterizing the processor's workload using the measured busy or idle durations includes incrementing by a predefined amount a particular value within a multi-value data structure that corresponds to a measured busy or idle duration, and decrementing all values within the multi-value data structure by a decay factor. In a further aspect, the processor is configured with processor-executable instructions such that generating a histogram-like data structure characterizing the processor's workload includes generating the histogram-like data structure in two central processing unit (CPU) cycles or less. In a further aspect, the processor is configured with processor-executable instructions such that using the histogram-like data structure includes adjusting a frequency of voltage of the processor based on the histogram-like data structure. In a further aspect, the processor is configured with processor-executable instructions such that using the histogram-like data structure includes determining a longest workload quantum based on the histogram-like data structure, generating a model of a predicted future workload based on the histogram-like data structure, and adjusting operational parameters of the processor to be commensurate with the predicted future workloads. In a further aspect, the processor is configured with processor-executable instructions such that adjusting the operational parameters of the processor to be commensurate with the predicted future workloads includes adjusting an operating frequency of the processor based on the longest workload quantum. In a further aspect, the processor is configured with processor-executable instructions such that adjusting an operating frequency of the processor includes scaling the voltage or frequency of the processor. In a further aspect, the processor is configured with processor-executable instructions such that adjusting the operational parameters of the processor to be commensurate with the predicted future workloads includes changing at least one quality of service value. In a further aspect, the processor is configured with processor-executable instructions such that using the histogram-like data structure includes determining a longest workload quantum within the histogram-like data structure, and determining a quality of service value based on the determined longest workload quantum. In a further aspect, the processor is configured with processor-executable instructions to perform operations further including controlling a component of the computing device based on the determined quality of service value. In a further aspect, the processor is configured with processor-executable instructions such that using the histogram-like data structure includes determining a longest workload quanta, comparing the longest workload quantum with a workload natural period, and determining a quality of service value based on this comparison.

Further aspects include a non-transitory computer readable storage medium having stored thereon processor-executable software instructions configured to cause a processor to perform operations including measuring busy or idle durations of the processor, generating a histogram-like data structure characterizing the processor's workload using the measured busy or idle durations, and using the histogram-like data structure to adjust at least one operational parameter of the computing device. In an aspect, the stored processor-executable software instructions are configured to cause the processor to perform operations such that generating a histogram-like data structure characterizing the processor's workload using the measured busy or idle durations includes incrementing by a predefined amount a particular value within a multi-value data structure that corresponds to a measured busy or idle duration, and decrementing all values within the multi-value data structure by a decay factor. In a further aspect, the stored processor-executable software instructions are configured to cause the processor to perform operations such that generating a histogram-like data structure characterizing the processor's workload includes generating the histogram-like data structure in two central processing unit (CPU) cycles or less. In a further aspect, the stored processor-executable software instructions are configured to cause the processor to perform operations such that using the histogram-like data structure includes adjusting a frequency of voltage of the processor based on the histogram-like data structure. In a further aspect, the stored processor-executable software instructions are configured to cause the processor to perform operations such that using the histogram-like data structure includes determining a longest workload quantum based on the histogram-like data structure, generating a model of a predicted future workload based on the histogram-like data structure, and adjusting operational parameters of the processor to be commensurate with the predicted future workloads. In a further aspect, the stored processor-executable software instructions are configured to cause the processor to perform operations such that adjusting the operational parameters of the processor to be commensurate with the predicted future workloads includes adjusting an operating frequency of the processor based on the longest workload quantum. In a further aspect, the stored processor-executable software instructions are configured to cause the processor to perform operations such that adjusting an operating frequency of the processor includes scaling the voltage or frequency of the processor. In a further aspect, the stored processor-executable software instructions are configured to cause the processor to perform operations such that adjusting the operational parameters of the processor to be commensurate with the predicted future workloads includes changing at least one quality of service value. In a further aspect, the stored processor-executable software instructions are configured to cause the processor to perform operations such that using the histogram-like data structure includes determining a longest workload quantum within the histogram-like data structure, and determining a quality of service value based on the determined longest workload quantum. In a further aspect, the stored processor-executable software instructions are configured to cause the processor to perform operations further including controlling a component of the computing device based on the determined quality of service value. In a further aspect, the stored processor-executable software instructions are configured to cause the processor to perform operations such that using the histogram-like data structure includes determining a longest workload quanta, comparing the longest workload quantum with a workload natural period, and determining a quality of service value based on this comparison.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1 is a diagram of processor activity of a typical mobile device processor that may be used to implement the various aspects.

FIG. 2 is a diagram of the histogram-like statistics that may be collected, analyzed, and used to control quality of service values, processor frequency and/or voltage.

FIG. 3 is a process flow diagram of an aspect method for generating histogram-like data structure that reflects a current distribution of busy and/or idle durations.

FIG. 4 is a process flow diagram of an aspect method for dynamically adjusting the operational parameters of a mobile computing device.

FIG. 5 is a process flow diagram of an aspect method for dynamically adjusting the frequency/voltage of a mobile computing device.

FIG. 6 is a process flow diagram of an aspect method for dynamically adjusting communication parameters of a mobile computing device in response to a computed quality of service.

FIG. 7 is an architectural diagram of an example system on chip suitable for implementing the various aspects.

FIG. 8 is a component block diagram of a mobile device suitable for implementing the various aspects.

FIG. 9 is a component block diagram of a lap top computer suitable for implementing the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile device” and “computing device” are used interchangeably herein to refer to any one or all of cellular telephones, personal data assistants (PDA's), palm-top computers, wireless electronic mail receivers (e.g., the Blackberry® and Treo® devices), multimedia Internet enabled cellular telephones (e.g., the Blackberry Storm®), Global Positioning System (GPS) receivers, wireless gaming controllers, and similar personal electronic devices which include a programmable processor and operate under battery power such that power conservation methods are of benefit.

The term “kernel” is used herein to refer to a component of an operating system that performs operating system tasks and serves as a bridge between software applications and the hardware. For example, a typical kernel's responsibilities may include managing system resources and facilitating the communications between the hardware components and the software components, which may be achieved via various inter-process communication mechanisms and system calls. Kernels are commonly organized into user space (where non-privileged code runs) and kernel space (where privileged code runs) segments. This separation is of particular importance in Android and other general public license (GPL) environments where code that is part of the kernel space must be GPL licensed, while code running in user-space doesn't need to be GPL licensed.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (DSP, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “resource” is used herein to refer to any of a wide variety of circuits (e.g., ports, clocks, buses, oscillators, etc.), components (e.g., memory), signals (e.g., clock signals), and voltages (e.g., voltage rails) which are used to support processors and clients running on a computing device.

Mobile device users expect their mobile devices to be able to perform a wide variety of tasks, such as those for making calls, playing music, browsing the Internet, playing games, watching movies, etc. Each of these activities demands a certain amount of processing, a certain quality of service, and a specific number of resources from the mobile device processor. Each activity may also place a specific workload on the processor that varies considerably from the workloads of the other activities and/or of other times. The various aspects provide methods of characterizing processor workloads and adjusting a mobile device's operating parameters (e.g., voltage, quality of service values, etc.) to adjust the device's performance and/or power consumption characteristics such that they are commensurate with the processor workloads. In an aspect, the workloads may be characterized using a histogram-like data structure that stores statistic information, which may be collected and computed at runtime based on the processor's busy/idle cycles and such that they do not add overhead or otherwise impact the device's performance.

Generally, maximizing processor performance (e.g., for speed) requires setting the supply voltage at the maximum allowable level. However, a typical mobile device does not require the maximum achievable performance at all times. Dynamic clock and voltage scaling (DCVS) methods may be implemented to reduce the power consumption of the processors when peak performance is not necessary. These methods take advantage of periods of low processor utilization by scaling the supply voltage and clock frequency such that the device's overall power consumption is reduced. However, existing scaling methods simply adjust the frequency/voltage of the processor such that power consumption is minimized, performance is maximized, or such that the system alternates between these two objectives. Simply configuring a computing device to maximize power saving or to maximize performance (or to alternate between the two objectives) does not always result in the most efficient utilization of the mobile device processor. In addition, maximizing the processor's performance may require adjusting the processor's quality of service (QoS) parameters.

Quality of service is a broad term that describes the quality of a connection between two or more communicating network devices. There may be many different factors that determine the ultimate quality of service provided to a mobile device, and the quality of service required by the device may fluctuate over time. Efficient utilization of network and mobile devices requires dynamically adapting the processors and resources to the required quality of service, which may include varying various quality of service values (e.g., measured error rates, frequency of dropped frames or packets, performance metrics, etc.) to meet the operational needs of the mobile device. While controlling the quality of service may help conserve power and processing resources, these same resources may be drained by overly complicated methods of measuring a connection's quality of service. The various aspects utilize network devices efficiently by computing the required levels of quality of service and adjusting the quality of service values to achieve the required quality of service without adding overhead or otherwise impacting the device's performance.

The various aspects provide methods and systems for controlling various processor and computing device processes based on a histogram-like data structure which is generated with a low-overhead process but yields a complex picture of the processor workloads, and busy/idle operations. This data structure can be used to control or manage a variety of parameters, such as voltage or frequency, or to infer information regarding a current operating state, such as determining a current quality of service, predicting processors workloads, and adjusting various operational parameters. Various aspects use the histogram-like data structure to determine an appropriate processor operating frequency and/or voltage to accommodate current workloads. Various aspects use the histogram-like data structure to estimate quality of service values in the context of other demands on the processor to enable better decision making on optimizing device performance using information not available via standard quality of service determinations. Various aspects predict upcoming workloads based on recent processor workload history and other statistics collected and/or calculated during runtime. Various aspects dynamically adjust the processor's performance level to be commensurate with the current workload and the required quality of service. Various aspects determine when to adjust the quality of service and/or frequency-voltage settings based upon the histogram-like data structure which reflects the dynamic nature of busy and idle durations.

As discussed above, mobile computing devices commonly encounter many different workloads over time. The character of these workloads may vary a great deal from user-to-user and task-to-task (e.g., from user touch-screen activities to video playback, from game play to web browsing, from video capture to music playback, etc.). Each of these varied workloads may be viewed as being “statistic in nature,” and each workload may be viewed as having its own statistic signature. As such, the processor workloads may be modeled and/or characterized using statistics collected in real time during the execution of various tasks or applications. The various embodiments provide a low overhead method for generating a histogram-like data structure which characterizes the busy/idle behavior of the processor. The histogram-like data structure may be used to model, characterize and/or predict future workloads, and the modeled workloads may be used to select/implement adaptive quality of service/voltage scaling methods that balance power consumption and performance levels such that they are commensurate with predicted future workloads.

By identifying current workload statistic signatures in a histogram-like data structure, the various aspects may implement methods suitable for adjusting the processor's operations to the specific workloads present on a mobile device. This targeted approach enables the generation and implementation of quality of service and scaling methods that are more efficient and adaptive than existing solutions.

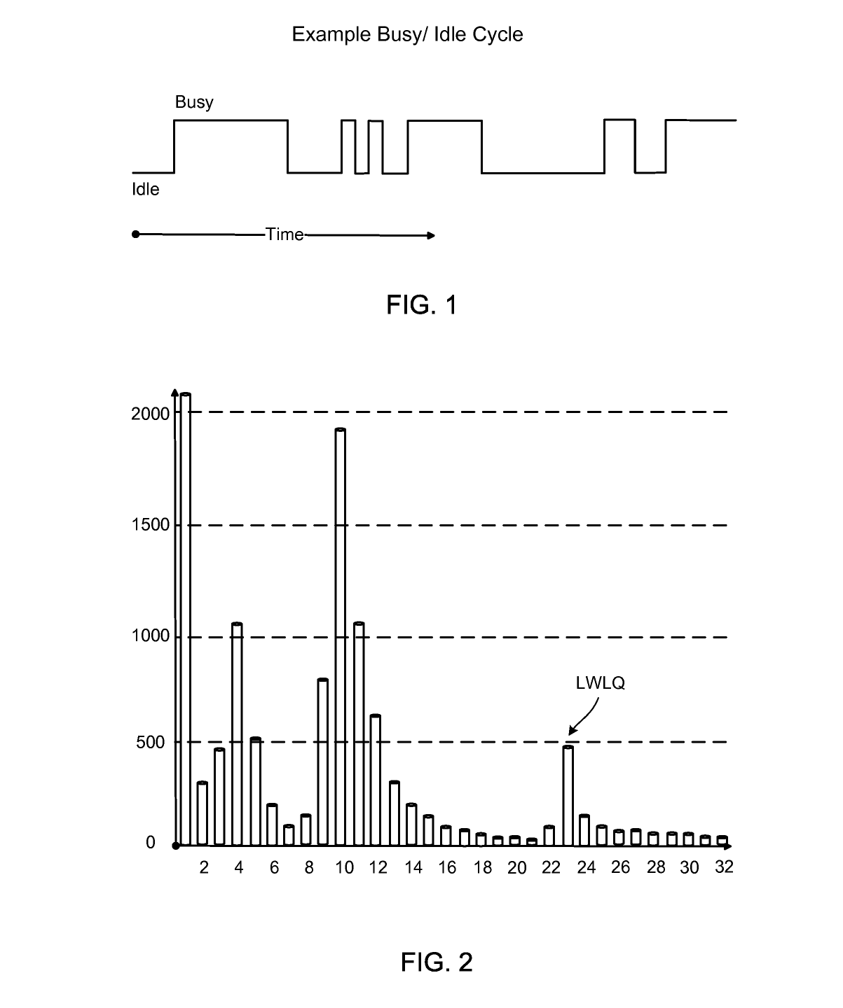

FIG. 1 illustrates processor activity of a typical mobile device processor that may be analyzed using the various aspects. The processor activity may include a sequence of alternating busy and idle periods (which may also be referred to herein as “busy/idle cycles”). FIG. 1 illustrates that each of the busy or idle periods may be of varying durations, and that these durations may vary a great deal over time depending upon the processes and applications being accomplished by the device processor(s) at any given instant. These busy/idle duration variations make it difficult to accurately predict future busy/idle cycles with certainty and/or to accurately model/characterize the workloads of device processor(s) without performing a significant number of power intensive computations. Moreover, there is no net energy saved by adjusting the quality of service or performing dynamic voltage scaling operations if the amount of energy required to model the workload is greater than or equal to the amount of energy saved by adjusting the operating parameters (e.g., scaling the frequency/voltage) of processors. The various aspects overcome these and other limitations by performing energy efficient computations/operations that do not require a significant amount of energy to characterize the workloads.

Generally, an operating system kernel is aware of processor busy and idle conditions, and may be configured to track and/or log each time a processor switches from a busy period to an idle period, and vice versa. For example, an operating system kernel may be configured to store timestamp information each time the processor transitions between busy and idle cycles. This timestamp information may be used to calculate previous busy and/or idle durations, and the duration values may be used to generate predictive models of current and future workloads based upon statistical calculations using these durations. Since the input information (e.g., timestamp information) is obtained from or made available by the kernel, the statistic values may be calculated using light weight processor operations which involve performing relatively simple calculations/operations (e.g., using shift operations instead of multiply operations).

As mentioned above, busy and idle lengths/durations may be calculated based on timestamps stored or available in the operating system kernel that are noted each time the processor switches from busy to idle and vice versa. Various aspects use the calculated busy or idle durations to generate a histogram-like data structure that can be used for determining a quality of service value. The histogram-like data structure provides a compact data set containing information regarding the overall processor workload, variability in the busy/idle ratio, and characteristics of the processor workload. This data structure, while relatively compact, may provide a comprehensive characterization of the demands on the processor. In an aspect, workload models may be generated using histogram-like data structures that represent the processor's busy/idle cycles. The histogram-like data structures may be implemented using a variety of known data structures (e.g., vectors, arrays, maps, lists, multimaps, graphs, etc.).

The various aspects take advantage of an observation that the demand on the processor (which may be reflected in the collected/calculated busy vs. idle statistics), may be correlated to a quality of service value. This is because the error correction algorithms required to recover lost bits consume processing time, but these processes are only required when bits are being lost in the communication channel. Thus, with better quality of service, fewer lost bits will be lost in communication, and there will be less processor demands to recover lost bits. On the other hand, as quality of service degrades, the bit-error-rate increases, thereby increasing the amount of processing required for recovering lost bits. Using this information, the various aspects measure quality of service in the context of other demands on the processor such that more actuate optimization decisions may be made using information and structures not available in standard quality of service determinations.

FIG. 2 is a graph illustrating the histogram-like statistics that may be collected, analyzed, and used to control quality of service values, operating parameters, and processor performance (e.g., via adjustments to processor frequency and/or voltage). The duration of a processor activity (i.e., busy and/or idle) measurement cycle may be divided up into a number of “bins” associated with duration increments. In the illustrated example of FIG. 2, the measurement cycle is 3.2 ms and the histogram-like structure contains 32 data fields (“bins”). Each of these bins may correspond to a range of busy (and/or idle) durations. For example, bin 1 may store an integer value representative of the fraction of time the busy (and/or idle) duration is between zero (0) and ninety nine (99) microseconds, bin 2 may store a value representative of the fraction of time the busy (and/or idle) duration is between one hundred (100) and one hundred and ninety nine (199) microseconds, bin 3 may store a value representative of the fraction of time the busy (and/or idle) duration is between two hundred (200) and two hundred and ninety nine (299) microseconds, etc.

In an aspect, the values in each bin may be calculated such that a time-averaging histogram representation of the distribution of the processor busy (and/or idle) durations may be generated efficiently. The various aspects provide mechanisms for generating histogram-like statistics data structures such that they may be maintained as a continuous quantity, and such that information regarding the instant processing environment is made available without complex processing or cumbersome overhead. In an aspect, the generated histogram-like data structures may be time weighted so that more recent information is more represented in the data set than old information. For example, in each cycle that one of the duration bins may be incremented based on the determined busy and/or idle duration, the remaining bins may be decremented by a decay factor, such as by multiplying the value in each bin by a fraction (e.g., 63/64).

In an aspect, the bins and the busy or idle durations they represent may correspond to a workload quantum. Generally, a repetitive workload has a number of repeated operations, and each repeated operations may take a certain amount of busy duration to finish. This duration typically only changes within a certain range, and thus, the repeated operation will repeatedly increment the same bin or immediately adjacent bins. In the various aspects, the repeated operations and their respective workload quanta may be represented in the peaks of the histogram, and the largest workload quantum (i.e., “LWLQ”) may be identified from the histogram-like structure as the right most peak.

The largest/longest workload quantum (e.g., LWLQ) within the histogram data structure may be used as an indication of the quality of service. If the longest workload quantum is in a long-duration bin, which is far to the right in the illustrated histogram (i.e., a high bin number in the example described above), this may indicate that there have been frequent long-duration processor busy cycles within the measurement cycle. This may be the case when the processor is being tasked frequently to perform long-duration calculations, which may be typical of various error correcting algorithms. Thus, frequent long duration calculations indicated by a far-right LWLQ value may correspond to low quality of service because the processor is frequently performing error-correction calculations. On the other hand, if the longest workload quantum is in a shorter-duration bin, which is toward the left in the illustrated histogram (i.e., a low bin number in the example described above), this may indicate that the processor is infrequently performing long-duration error correction calculations (because the algorithm described above is time-weighted) or performing relatively simple error correction processes, indicating that the quality of service is likely high.

In an aspect, the largest/longest workload quantum may be compared with the natural period of the workload. A ratio of longest workload quantum to the workload natural period above a certain value (e.g., a value of 1) may correspond to a bad quality of service value, whereas a ratio below the value may indicate a good quality of service.

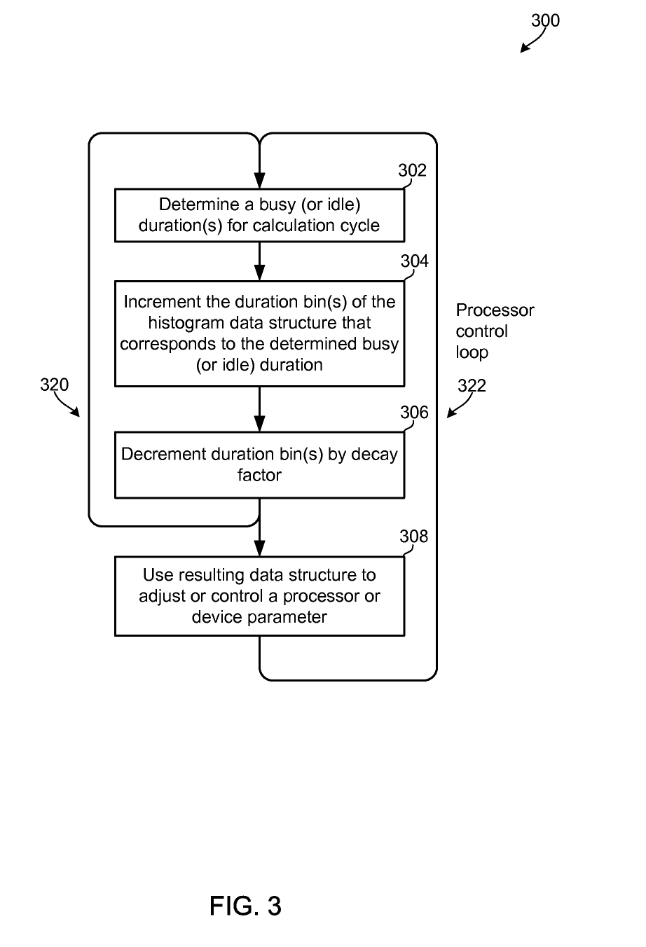

FIG. 3 illustrates an aspect method 300 for using information derived from a histogram-like data structure to characterize processor workloads and adjust or control a processor or an operational parameter. In block 302, a mobile device processor may measure, calculate or otherwise determine busy and/or idle durations for a calculation cycle. The busy and/or idle durations may be calculated from the information known to the kernel, and determining such durations may include performing time-weighting (i.e., continuous decaying of values) operations to provide a current picture of the processing environment. In block 304, a bin in the busy and/or idle duration histogram-like data structure corresponding to the value (i.e., the bin within which the calculated duration falls) may be incremented by a standard amount. For example, the bin may be incremented by 0x1000000. In block 306, as part of the same calculation cycle, the remaining bins, or all bins, may be decremented or decayed by a decay factor (e.g., 63/64). The histogram generation loop 320 may then be repeated, and as a result of this loop 320, within a relatively short time (e.g., 64 cycles), the bins making up the data structure may reflect a current distribution of busy and/or idle durations of the processor time averaged over the past cycles (e.g., the past ˜64 cycles) with emphasis on the most recent cycles. In block 308, as part of the processor control loop 322, the resulting data structure may be used to adjust or control a device processor or parameter.

In an aspect, a mobile device may be configured to model/characterize the processor workloads by first calculating and generating a histogram-like data structure using busy/idle time stamps or duration information obtained from the operating system kernel. The models/characterizations of the workloads may then be used to more accurately adjust the quality of service and/or scale the frequency and voltage via voltage/frequency scaling methods with the objective of balancing power savings against processor performance on the current workload. In an aspect, an optimal operating frequency rate may be selected such that the processor performance is commensurate with the actual/predicted workload while power savings are maximized and/or the impact on the user experience is minimized (e.g., users do not experience noticeable performance loss).

In an aspect, statistic values may be calculated in terms of an idle/busy ratio. The idle/busy ratio may be calculated as being equal to an average of the idle (or busy) durations divided by the sum of the average idle duration and the average busy duration. A target idle/busy ratio may be set based on the calculated average statistics and/or the identified workload. In an aspect, the frequency (and/or voltage) of the processor may be adjusted in a control loop configured to steer the current idle/busy ratio towards a target ratio. In an aspect, the target busy/idle ratio may be a value that provides an optimum balance between processor performance and power savings. In an aspect, the frequency/voltage of the processor may be adjusted a bit higher than the value indicated by the running average idle/busy ratio in order to provide extra processing capability to accommodate occasional peaks in processor workload.

In striking a balance between power savings and processor performance, the competing parameters of processor speed and power consumption may be evaluated in view of the current busy/idle cycle statistics. If the processor is operated at or near its maximum frequency (i.e., CPU cycles per second), it will rapidly complete each processor or operation; however, it will operate at higher voltage and thus exhibit a higher power consumption rate. If the processor is not particularly busy and is operated at or near the maximum frequency, it will quickly accomplish each of the operations, and the idle durations between operations will be long (i.e., the busy-to-idle ratio will be small). While the processor is idle but operating at high voltage, its power consumption will be high even though it is not actively working most of the time. Thus, operating the processor at high frequency/high voltage when the workload is light (i.e., the busy-to-idle ratio is small) may result in unnecessary battery drain with no performance benefit to the user.

On the other hand, operating the processor at a low frequency reduces the operating voltage, and thus lowers power consumption. While operating at low frequency the processor will require more time to complete each task. As a result, the amount of time the processor is idle may be short, and thus the busy-to-idle ratio may be large. When the processor workload is light, the longer time to complete each operation may not impact the user performance if the processor is able to keep up with all of the tasks being presented to it. However, if the processor operating frequency is low when the processor workload is high, the processor may not be able to keep up with the demand so operations may be queued and the user may experience slow or poor performance.

Thus, operating at a frequency that minimizes the idle time (and thus maximizes the busy time) of the processor can achieve the greatest power savings provided the processor is able to keep up with demand. In a simplistic analysis, reducing the processor frequency/voltage to the point where idle durations are small, but not zero would achieve the maximum power savings without decrementing performance. However, in typical operations, the variability in busy and a idle durations illustrated in FIGS. 1 and 2, both instantaneously and over longer durations (e.g., during different evolutions in an application) render the simplistic analysis infeasible. If the frequency/voltage is set according to peaks in processor workload (i.e., shortest idle durations), then the processor will consume more power on average than necessary because such peaks may occur infrequently, and thus on average, the processor is operating at an unnecessarily high frequency/voltage. If the frequency/voltage is set according to valleys in processor workload (i.e., longest idle durations), then the processor will save more power but frequently will exhibit poor performance when it is unable to keep up with the peaks in workload.

In an aspect, the voltage and frequency of the processor may be adjusted in a dynamic clock and voltage scaling (DCVS) algorithm based on the comparison between the target ratio and the actual idle/busy ratio. For example, the processor frequency may be decreased to save power, or increased to insure adequate performance, based on the comparison between the target ratio and the actual idle/busy ratio. In an aspect, the processor's frequency may be decreased if the actual idle/busy ratio is lower than the target ratio, and the processor's frequency may be increased if the idle/busy ratio is higher than the target ratio. In an aspect, the target ratio may be adjusted up or down, and the frequency/voltage of the processor may be scaled towards the adjusted target ratio.

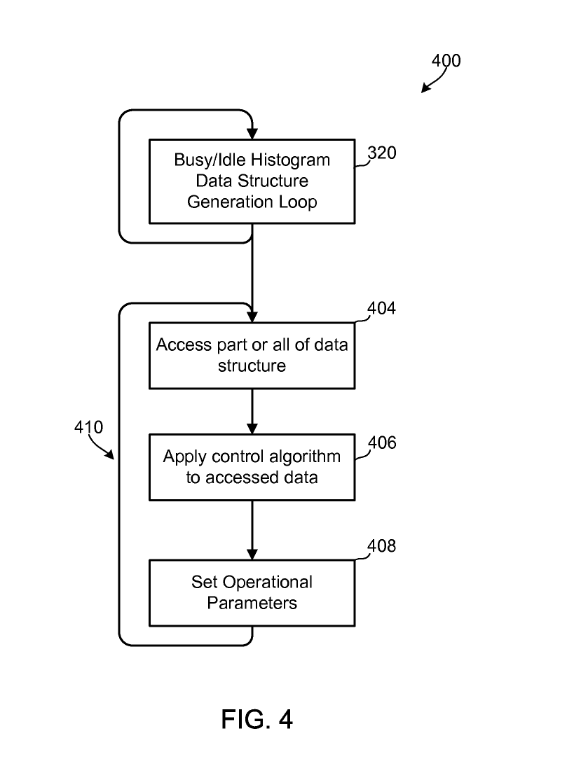

FIG. 4 illustrates an aspect method 400 for dynamically adjusting the operational parameters of a mobile device processor. In block 320, a histogram generation loop 320 similar to the a histogram generation loop 320 illustrated in FIG. 3 may be repeated such that the bins making up the histogram-like data structure reflect a current distribution of busy and/or idle durations of the processor time averaged over the past cycles (e.g., the past ˜64 cycles) with emphasis on the most recent cycles. As part of these operations, the lengths, recurrence, and other characteristics of the idle and/or busy durations may be measured, and an idle/busy ratio may be calculated. In an aspect, the idle/busy ratio may be calculated as the average of the idle (or busy) durations divided by the sum of the average idle duration and the average busy duration. In other aspects, other formulas may also be used to calculate the running averages. In an aspect the target idle/busy ratio may be calculated or adjusted based upon the statistic values in order to provide an optimum balance between processor performance and power savings in view of the current operating conditions. In an aspect, collected statistic values may be used to identify future processor demands and/or to identify circumstances in which the target ratio is not likely be accurate and adjust the target ratio accordingly.

Returning to FIG. 4, in block 404, one or more portions of the histogram-like data structure may be accessed to determine the processor's workload. In block 406, a control algorithm may be applied to the accessed portions to predict a future workload. In block 408, the operation parameters may be set by mobile device processor such that the quality of service (and/or frequency/voltage) of the mobile device processor is adjusted to match the processor workload. These operations may be repeated in a control loop 410 configured to steer the current idle/busy ratio towards a desired target ratio in a continuous, dynamic manner. In an aspect, the target ratio may be adjusted dynamically. Adjustments to the target idle/busy ratio may occur before, at the same time or after the adjustments are made to the operational parameters (e.g., to adjust the processor frequency/voltage). In an aspect, the adjustments to the operational parameters may be accomplished in a parallel process such that they occur concurrently with the adjustments to the target idle/busy ratio.

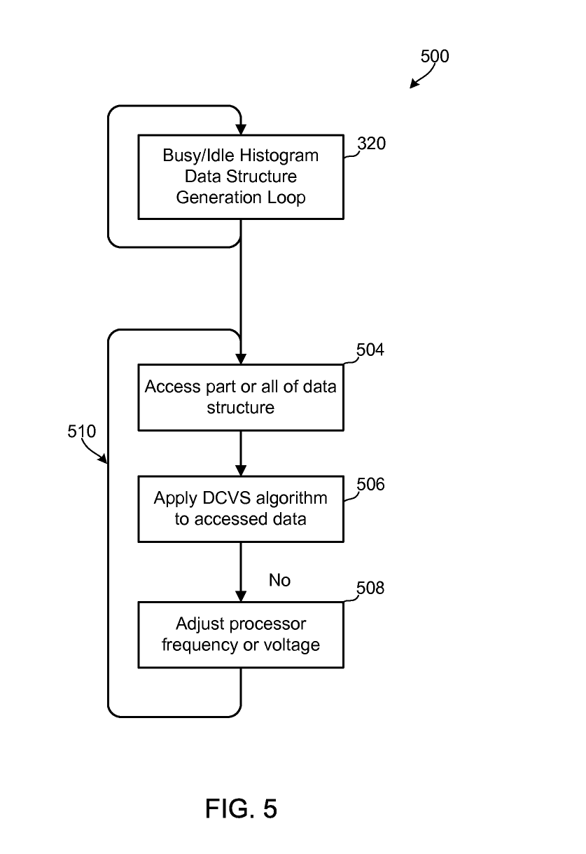

FIG. 5 illustrates an aspect method 500 for scaling the frequency/voltage of a mobile device processor. In block 320, a histogram generation loop 320 may be repeated such that the bins making up the histogram-like data structure reflect a current distribution of busy and/or idle durations, similar to the a histogram generation loop 320 illustrated in FIGS. 3 and 4. In block 504, one or more portions of the histogram-like data structure may be accessed to determine the processor's workload. In block 506, a dynamic clock and voltage scaling algorithm may be applied to the accessed portions to determine the optimal voltage or frequency for the predicted workloads. In block 508, the frequency/voltage of the mobile device processor may be adjusted to match the predicted processor workload. Blocks 504-508 may be repeated in a control loop 510.

In an aspect, a quality of service value may be determined or estimated (or a proxy for quality of service may be determined) based on the longest workload quantum bin within the histogram-like data structure, or the ratio of the longest workload quantum bin to the workload natural period. In an aspect, the determined/estimated quality of service may be used to control or adjust the device (e.g., to change an error encoding scheme), boost or reduce transceiver power, increase or reduce transmission rates, etc. Since the histogram-like data structure may be continuously upgraded (e.g., via the histogram generation loop 320), the measure of quality of service provided by the longest workload quantum may be used to continuously monitor and react to changes in the quality of service experienced by the device.

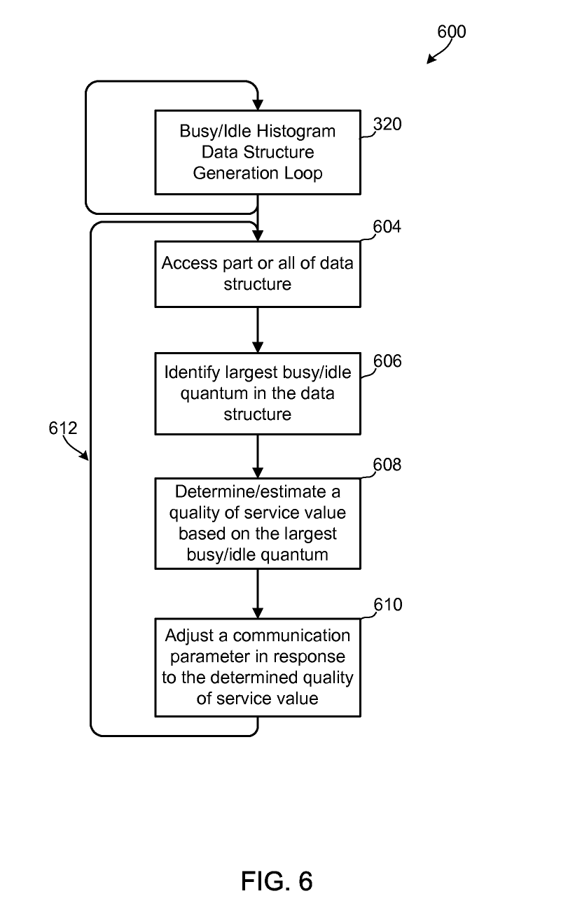

FIG. 6 illustrates an aspect method 600 for adjusting communication parameters based on estimated quality of service values. In block 320, a histogram generation loop 320 similar to the a histogram generation loop 320 illustrated in FIG. 3 may be repeated such that the bins making up the histogram-like data structure reflect a current distribution of busy and/or idle durations of the processor time averaged over the past cycles (e.g., the past ˜64 cycles) with emphasis on the most recent cycles. In block 604, one or more portions of the histogram-like data structure may be accessed to determine a processor workload.

In block 606, a largest workload quantum, or the ratio of the largest workload quantum bin to the workload natural period, may be computed. In block 608, a quality of service value may be determined or estimated (or a proxy for quality of service may be determined) based on the longest workload quantum bin, or the ratio of the longest workload quantum bin to the workload natural period. in block 610, the determined/estimated quality of service may be used to control or adjust the device (e.g., to change an error encoding scheme), boost or reduce transceiver power, increase or reduce transmission rates, etc. Since the histogram-like data structure may be continuously upgraded (e.g., via the histogram generation loop 320), the measure of quality of service provided by the longest workload quantum may be used to continuously monitor and react to changes in the quality of service experienced by the device via control loop 612.

The various aspects utilize histogram-like statistics and structures to capture and model a running, busy, idle duration distribution over past history for a processor. The time span may divided into a number of intervals (e.g., 32 intervals), the weight of each interval may be represented by an integer, and all integers may be initialized to the same value (e.g., 0x2000000). Each weight may be updated on every busy/idle cycle. For example, if the time span is divided into 32 segments, all the elements may decay as:

Nj=Nj−(Nj>>6); //shift by 6 bits, × 63/64

Nj+=0x1000000 for the element the duration falls in (large increment reduce rounding error and gives record of rare event history).

Since all histogram elements are initialized with equal values (e.g., 0x2000000), the sum of all the elements remains roughly constant over time (e.g., at approximately 0x40000000 for 32 segments). In the above example, for a workload quanta that occurs on every cycle, Nj may be determined to be stable at 0x40000000; for a workload quanta that occurs every other cycle, Nj may be determined to be stable at above 0x20000000; and for a workload quanta that occurs every 8 cycles, Nj may be determined to be stable at above 0x8000000. In this example, mapping the time durations to an array element may results in:

| Element | 0 | 1~9 | 10~19 | 20~27 | 28 | 29 | 30 | 31 |
|---|---|---|---|---|---|---|---|---|
| Busy | 0~.5 | .5~1.5 | 9.5~11.5 | 29.5~33.5 | 61.5-80 | 80-100 | 100~800 | >800 |

| | | | | | |
|---|---|---|---|---|---|
| Idle | 0~.25 | .25~.75 | 9.75~10.75 | 19.75~800 | >800 |

Using such mappings, Nj may be decayed to half of what it was in 45 busy/idle cycles if it is not hit. A residual value below 0x1000000 may measure how old a rare event happened in the past. Every 45 cycles, the element value may have one more leading zero in its binary form. This may be used keep a history of about 900 cycles before the residual value reduces to the minimum value of 63. The busy duration may be weighted by a current CPU_freq parameter. A fixed workload quanta may show up at same distribution point regardless current CPU_freq.

As mentioned above, a repetitive workload may include fixed types of repeated operation, and each type of repeated operation may require a certain amount of CPU cycles to finish. This amount of CPU work is a workload quanta, which shows up as a peak in the workload histogram structure. For the repetitive workload, the largest workload quanta (LWLQ) for a given workload (e.g., the right most peak illustrated in FIG. 2) scaled by current CPU_Freq can be a good measure of QoS. The relative value of the LWLQ and the natural period (WLNP) of the workload gives a good measure of current WL QoS. Larger than 100% of LWLQ to WLNP ratio means less than satisfying QoS. With less than 100% ratio, the idle histogram distribution may give a quantitative measure of the head room. With 32 segments, the histogram updated per cycle may be less than 100 CPU cycles (less than 50 cycles if optimized).

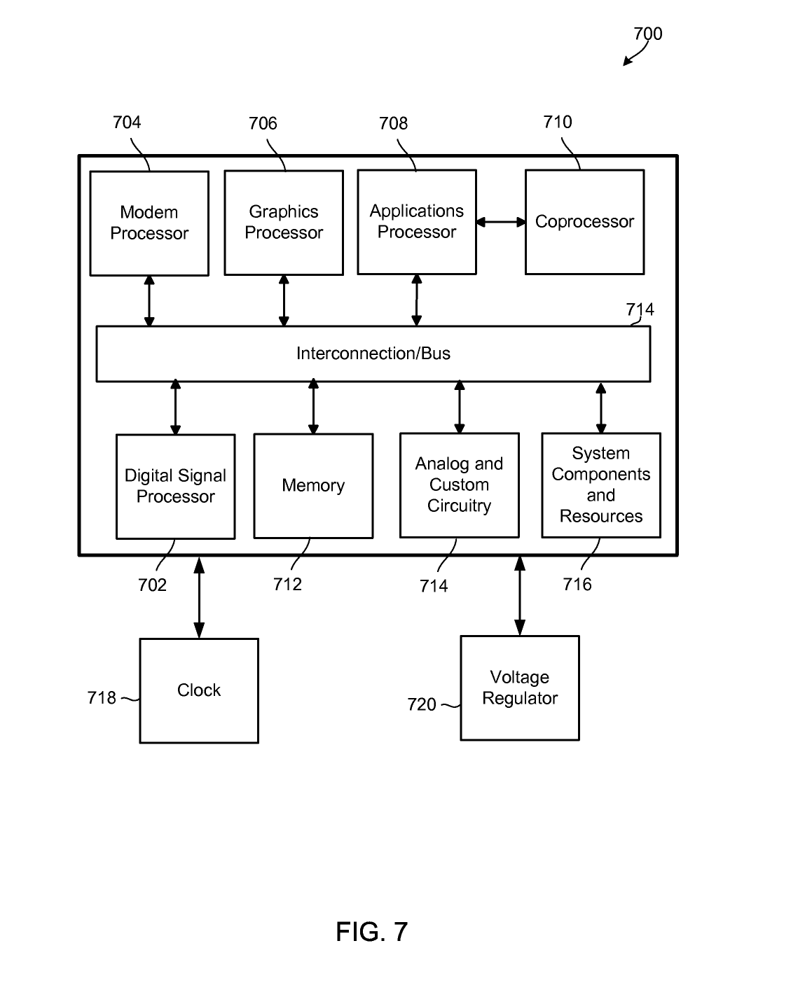

The various aspects may be implemented on a number of computing devices and processor systems, including any of the processors in a system-on-chip (SOC). FIG. 7 is an architectural diagram illustrating an example system-on-chip (SOC) 700 architecture that may be used to implement the various aspects. The SOC 700 may include a number of heterogeneous processors, such as a digital signal processor (DSP) 702, a modem processor 704, a graphics processor 706, and an application processor 708. The SOC 700 may also include one or more coprocessors 710 (e.g., vector co-processor) connected to one or more of the processors. Each processor may include one or more cores, and each processor/core may perform operations independent of the other processors/cores. For example, the SOC 700 may include a processor that executes a first type of operating system (e.g., FreeBSD, LINIX, OS X, etc.) and a processor that executes a second type of operating system (e.g., Microsoft Windows 7). The various aspects may be applied to each of the processors and/or cores to improve performance, efficiency and/or to reduce the overall power consumption of the mobile device.

The SOC 700 may also include analog circuitry and custom circuitry 714 for managing sensor data, analog-to-digital conversions, wireless data transmissions, and performing other specialized operations, such as processing encoded audio signals for games and movies. The SOC 700 may further include system components and resources 716, such as voltage regulators, oscillators, phase-locked loops, peripheral bridges, data controllers, memory controllers, system controllers, access ports, timers, and other similar components used to support the processors and clients running on a computing device.

The system components 716 and custom circuitry 714 may include circuitry to interface with peripheral devices, such as cameras, electronic displays, wireless communication devices, external memory chips, etc. The processors 702, 704, 706, 708 may be interconnected to one or more memory elements 712, system components, and resources 716 and custom circuitry 714 via an interconnection/bus module, which may include an array of reconfigurable logic gates and/or implement a bus architecture (e.g., CoreConnect, AMBA, etc.). Communications may be provided by advanced interconnects, such as high performance networks-on chip (NoCs).

The SOC 700 may include an input/output module (not illustrated) for communicating with resources external to the SOC, such as a clock 718 and a voltage regulator 720. Resources external to the SOC (e.g., clock 718, voltage regulator 720) may be shared by two or more of the internal SOC processors/cores (e.g., DSP 702, modem processor 704, graphics processor 706, applications processor 708, etc.).

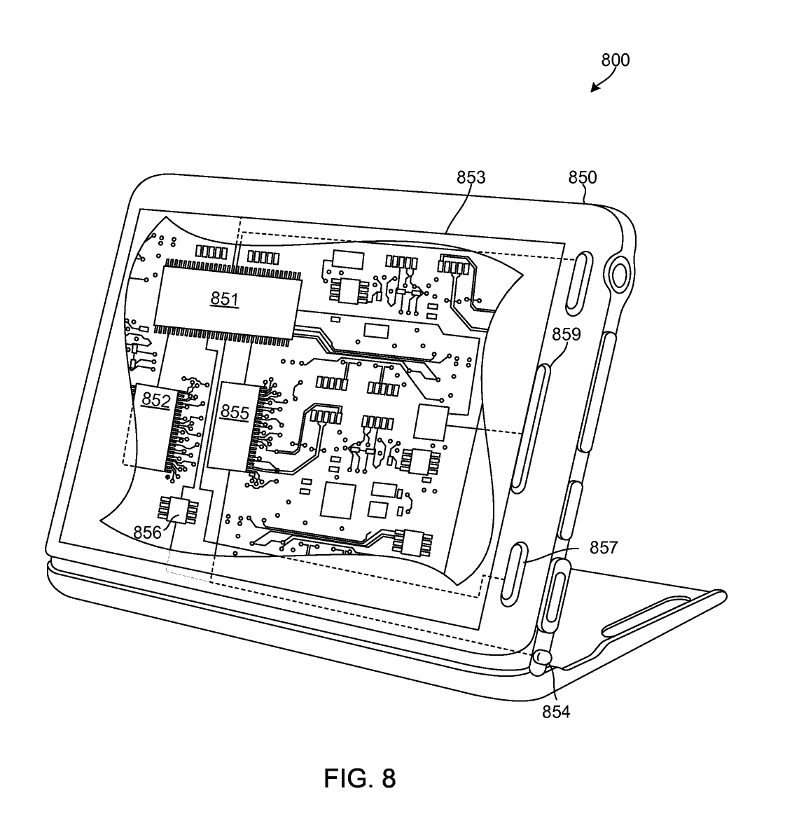

Typical mobile devices 800 suitable for use with the various aspects will have in common the components illustrated in FIG. 8. For example, an exemplary mobile receiver device 850 may include a processor 851 coupled to internal memory 852, a display 853, and to a speaker 859. Additionally, the mobile device 850 may have an antenna 854 for sending and receiving electromagnetic radiation that is connected to a mobile multimedia receiver 856 coupled to the processor 851. In some aspects, the mobile multimedia receiver 856 may include an internal processor 858, such as a digital signal processor (DSP) for controlling operations of the receiver 856 and communicating with the device processor 851. Mobile devices typically also include a key pad 856 or miniature keyboard and menu selection buttons or rocker switches 857 for receiving user inputs.

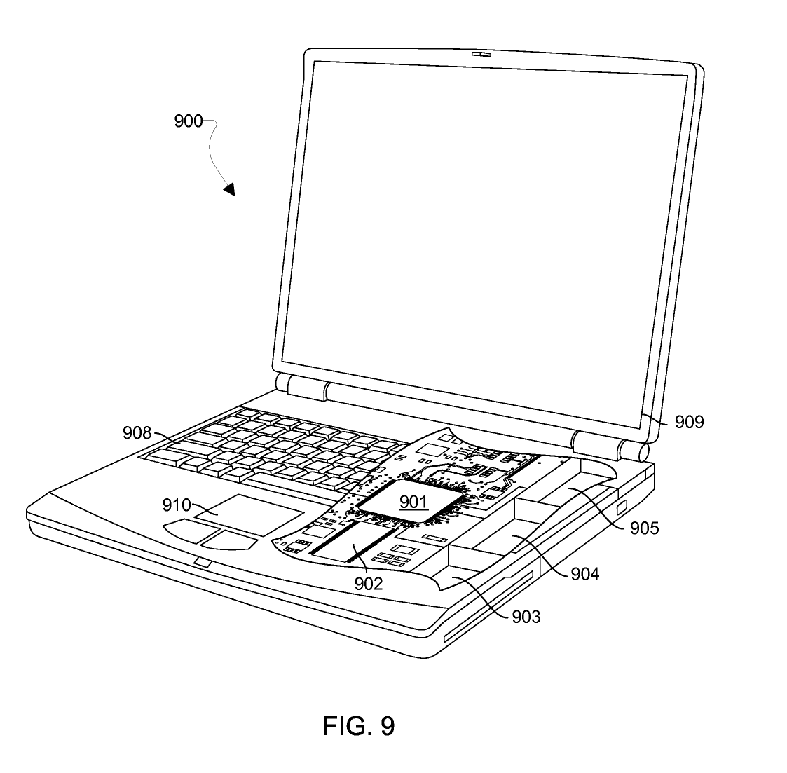

While the various aspects may provide significant performance enhancements for mobile computing devices, other forms of computing devices, including personal computers and laptop computers, may also benefit from pre-parsing of the dynamic language scripts. Such computing devices typically include the components illustrated in FIG. 9 which illustrates an example personal laptop computer 900. Such a personal computer 900 generally includes a processor 901 coupled to volatile memory 902 and a large capacity nonvolatile memory, such as a disk drive 903. The computer 900 may also include a compact disc (CD) and/or DVD drive 904 coupled to the processor 901. The computer device 900 may also include a number of connector ports coupled to the processor 901 for establishing data connections or receiving external memory devices, such as a network connection circuit 905 for coupling the processor 901 to a network. The computer 900 may further be coupled to a keyboard 908, a pointing device such as a mouse 910, and a display 909 as is well known in the computer arts.

The processors 801, 901 may be any programmable microprocessor, microcomputer or multiple processor chip or chips that may be configured by software instructions (applications) to perform a variety of functions, including the functions of the various aspects described herein. In some mobile devices, multiple processors 801, 901 may be provided, such as one processor dedicated to wireless communication functions and one processor dedicated to running other applications. Typically, software applications may be stored in the internal memory 802, 902 before they are accessed and loaded into the processor 801, 901. In some mobile devices, the processor 801, 901 may include internal memory sufficient to store the application software instructions. In some mobile devices, the secure memory may be in a separate memory chip coupled to the processor 801, 901. The internal memory 802, 902 may be a volatile or nonvolatile memory, such as flash memory, or a mixture of both. For the purposes of this description, a general reference to memory refers to all memory accessible by the processor 801, 901, including internal memory 802, 902, removable memory plugged into the mobile device, and memory within the processor 801, 901 itself.

The foregoing method descriptions and the process flow diagrams are provided merely as illustrative examples and are not intended to require or imply that the steps of the various aspects must be performed in the order presented. As will be appreciated by one of skill in the art the order of steps in the foregoing aspects may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), a DSP within a multimedia broadcast receiver chip, an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The operations of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method for dynamically adjusting operations of a computing device having a processor, comprising:
measuring busy or idle durations of the processor;
generating a histogram-like data structure characterizing the processor's workload using the measured busy or idle durations; and
using the histogram-like data structure to adjust at least one operational parameter of the computing device.

2. The method of claim 1, wherein generating a histogram-like data structure characterizing the processor's workload using the measured busy or idle durations comprises:
incrementing by a predefined amount a particular value within a multi-value data structure that corresponds to a measured busy or idle duration; and
decrementing all values within the multi-value data structure by a decay factor.

3. The method of claim 1, wherein generating a histogram-like data structure characterizing the processor's workload comprises generating the histogram-like data structure in two central processing unit (CPU) cycles or less.

4. The method of claim 1, wherein using the histogram-like data structure comprises adjusting a frequency of voltage of the processor based on the histogram-like data structure.

5. The method of claim 1, wherein using the histogram-like data structure comprises:
determining a longest workload quantum based on the histogram-like data structure;
generating a model of a predicted future workload based on the histogram-like data structure; and
adjusting operational parameters of the processor to be commensurate with the predicted future workloads.

6. The method of claim 5, wherein adjusting the operational parameters of the processor to be commensurate with the predicted future workloads comprises adjusting an operating frequency of the processor based on the longest workload quantum.

7. The method of claim 5, wherein adjusting an operating frequency of the processor comprises scaling a voltage or frequency of the processor.

8. The method of claim 5, wherein adjusting the operational parameters of the processor to be commensurate with the predicted future workloads comprises changing at least one quality of service value.

9. The method of claim 1, wherein using the histogram-like data structure comprises:
determining a longest workload quantum within the histogram-like data structure; and
determining a quality of service value based on the determined longest workload quantum.

10. The method of claim 9, further comprising:
controlling a component of the computing device based on the determined quality of service value.

11. The method of claim 1, wherein using the histogram-like data structure comprises:
determining a longest workload quanta;
comparing the longest workload quantum with a workload natural period; and
determining a quality of service value based on this comparison.

12. A computing device, comprising:
a processor;
means for measuring busy or idle durations of the processor;
means for generating a histogram-like data structure characterizing the processor's workload using the measured busy or idle durations; and
means for using the histogram-like data structure to adjust at least one operational parameter of the computing device.

13. The computing device of claim 12, wherein means for generating a histogram-like data structure characterizing the processor's workload using the measured busy or idle durations comprises:
means for incrementing by a predefined amount a particular value within a multi-value data structure that corresponds to a measured busy or idle duration; and
means for decrementing all values within the multi-value data structure by a decay factor.

14. The computing device of claim 12, wherein means for generating a histogram-like data structure characterizing the processor's workload comprises means for generating the histogram-like data structure in two central processing unit (CPU) cycles or less.

15. The computing device of claim 12, wherein means for using the histogram-like data structure comprises means for adjusting a frequency of voltage of the processor based on the histogram-like data structure.

16. The computing device of claim 12, wherein means for using the histogram-like data structure comprises:
means for determining a longest workload quantum based on the histogram-like data structure;
means for generating a model of a predicted future processor workload based on the histogram-like data structure; and
means for adjusting operational parameters of the processor to be commensurate with the predicted future workloads.

17. The computing device of claim 16, wherein means for adjusting the operational parameters of the processor to be commensurate with the predicted future workloads comprises means for adjusting an operating frequency of the processor based on the longest workload quantum.

18. The computing device of claim 16, wherein means for adjusting an operating frequency of the processor comprises means for scaling a voltage or frequency of the processor.

19. The computing device of claim 16, wherein means for adjusting the operational parameters of the processor to be commensurate with the predicted future workloads comprises means for changing at least one quality of service value.

20. The computing device of claim 12, wherein means for using the histogram-like data structure comprises:
means for determining a longest workload quantum within the histogram-like data structure; and
means for determining a quality of service value based on the determined longest workload quantum.

21. The computing device of claim 20, further comprising:
means for controlling a component of the computing device based on the determined quality of service value.

22. The computing device of claim 12, wherein means for using the histogram-like data structure comprises:
means for determining a longest workload quanta;
means for comparing the longest workload quantum with a workload natural period; and
means for determining a quality of service value based on this comparison.

23. A computing device, comprising:
a memory; and
a processor coupled to the memory, wherein the processor is configured with processor-executable instructions to perform operations comprising:
measuring busy or idle durations of the processor;
generating a histogram-like data structure characterizing the processor's workload using the measured busy or idle durations; and
using the histogram-like data structure to adjust at least one operational parameter of the computing device.

24. The computing device of claim 23, wherein the processor is configured with processor-executable instructions such that generating a histogram-like data structure characterizing the processor's workload using the measured busy or idle durations comprises:
incrementing by a predefined amount a particular value within a multi-value data structure that corresponds to a measured busy or idle duration; and
decrementing all values within the multi-value data structure by a decay factor.

25. The computing device of claim 23, wherein the processor is configured with processor-executable instructions such that generating a histogram-like data structure characterizing the processor's workload comprises generating the histogram-like data structure in two central processing unit (CPU) cycles or less.

26. The computing device of claim 23, wherein the processor is configured with processor-executable instructions such that using the histogram-like data structure comprises adjusting a frequency of voltage of the processor based on the histogram-like data structure.

27. The computing device of claim 23, wherein the processor is configured with processor-executable instructions such that using the histogram-like data structure comprises:
determining a longest workload quantum based on the histogram-like data structure;
generating a model of a predicted future workload based on the histogram-like data structure; and
adjusting operational parameters of the processor to be commensurate with the predicted future workloads.

28. The computing device of claim 27, wherein the processor is configured with processor-executable instructions such that adjusting the operational parameters of the processor to be commensurate with the predicted future workloads comprises adjusting an operating frequency of the processor based on the longest workload quantum.

29. The computing device of claim 27, wherein the processor is configured with processor-executable instructions such that adjusting an operating frequency of the processor comprises scaling a voltage or frequency of the processor.

30. The computing device of claim 27, wherein the processor is configured with processor-executable instructions such that adjusting the operational parameters of the processor to be commensurate with the predicted future workloads comprises changing at least one quality of service value.

31. The computing device of claim 23, wherein the processor is configured with processor-executable instructions such that using the histogram-like data structure comprises:
determining a longest workload quantum within the histogram-like data structure; and
determining a quality of service value based on the determined longest workload quantum.

32. The computing device of claim 31, wherein the processor is configured with processor-executable instructions to perform operations further comprising:
controlling a component of the computing device based on the determined quality of service value.

33. The computing device of claim 23, wherein the processor is configured with processor-executable instructions such that using the histogram-like data structure comprises:
determining a longest workload quanta;
comparing the longest workload quantum with a workload natural period; and
determining a quality of service value based on this comparison.

34. A non-transitory computer readable storage medium having stored thereon processor-executable software instructions configured to cause a processor to perform operations comprising:
measuring busy or idle durations of the processor;
generating a histogram-like data structure characterizing the processor's workload using the measured busy or idle durations; and
using the histogram-like data structure to adjust at least one operational parameter of the computing device.

35. The non-transitory computer readable storage medium of claim 34, wherein the stored processor-executable software instructions are configured to cause the processor to perform operations such that generating a histogram-like data structure characterizing the processor's workload using the measured busy or idle durations comprises:
incrementing by a predefined amount a particular value within a multi-value data structure that corresponds to a measured busy or idle duration; and
decrementing all values within the multi-value data structure by a decay factor.

36. The non-transitory computer readable storage medium of claim 34, wherein the stored processor-executable software instructions are configured to cause the processor to perform operations such that generating a histogram-like data structure characterizing the processor's workload comprises generating the histogram-like data structure in two central processing unit (CPU) cycles or less.

37. The non-transitory computer readable storage medium of claim 34, wherein the stored processor-executable software instructions are configured to cause the processor to perform operations such that using the histogram-like data structure comprises adjusting a frequency of voltage of the processor based on the histogram-like data structure.

38. The non-transitory computer readable storage medium of claim 34, wherein the stored processor-executable software instructions are configured to cause the processor to perform operations such that using the histogram-like data structure comprises:
determining a longest workload quantum based on the histogram-like data structure;
generating a model of a predicted future workload based on the histogram-like data structure; and
adjusting operational parameters of the processor to be commensurate with the predicted future workloads.

39. The non-transitory computer readable storage medium of claim 38, wherein the stored processor-executable software instructions are configured to cause the processor to perform operations such that adjusting the operational parameters of the processor to be commensurate with the predicted future workloads comprises adjusting an operating frequency of the processor based on the longest workload quantum.

40. The non-transitory computer readable storage medium of claim 38, wherein the stored processor-executable software instructions are configured to cause the processor to perform operations such that adjusting an operating frequency of the processor comprises scaling a voltage or frequency of the processor.

41. The non-transitory computer readable storage medium of claim 38, wherein the stored processor-executable software instructions are configured to cause the processor to perform operations such that adjusting the operational parameters of the processor to be commensurate with the predicted future workloads comprises changing at least one quality of service value.

42. The non-transitory computer readable storage medium of claim 34, wherein the stored processor-executable software instructions are configured to cause the processor to perform operations such that using the histogram-like data structure comprises:
determining a longest workload quantum within the histogram-like data structure; and
determining a quality of service value based on the determined longest workload quantum.

43. The non-transitory computer readable storage medium of claim 42, wherein the stored processor-executable software instructions are configured to cause the processor to perform operations further comprising:
controlling a component of the computing device based on the determined quality of service value.

44. The non-transitory computer readable storage medium of claim 34, wherein the stored processor-executable software instructions are configured to cause the processor to perform operations such that using the histogram-like data structure comprises:
determining a longest workload quanta;
comparing the longest workload quantum with a workload natural period; and
determining a quality of service value based on this comparison.
